(19) United States
(12) Patent Application Publication
(10) Pub. No.: US 2026/0340283 A1
(43) Pub. Date: Oct. 29, 2026

(54) EFFICIENT LARGE LANGUAGE MODEL GENERATION THROUGH SPECULATIVE DECODING OVER HOMOMORPHIC ENCRYPTION

(71) Applicant: International Business Machines Corporation, Armonk, NY (US)

(72) Inventors: Matan Avitan, Rishon Le Zion (IL); Itamar Zimerman, Tel-Aviv (IL); Moran Baruch, Petah Tikva (IL)

(21) Appl. No.: 19/189,168

(22) Filed: Apr. 24, 2025

(51) Int. Cl. G06F 40/274; G06F 40/284

(52) U.S. Cl. CPC G06F 40/274; G06F 40/284

(57) ABSTRACT

Using a small language model, k tokens are predicted based on given input text; k large language model (LLM) tokens are predicted using a plurality of instances of a large language model based on the given input text. Each token produced by the small language model is compared to a corresponding LLM token. Each LLM token that resulted in a match is concatenated with input tokens of a current context input. Text is generated by predicting, using the small language model, an additional k tokens based on the concatenated tokens.

### BACKGROUND

The present invention relates generally to the electrical, electronic and computer arts and, more particularly, to machine learning.

Large language models (LLMs) generally tend to have lengthy inference times. Fully homomorphic encryption (FHE)-based LLMs exhibit even longer inference times due to the added complexity of their polynomial approximations. Moreover, conventional homomorphic encryption (HE) schemes support only polynomial operations (such as addition, subtraction and multiplication) limiting the algorithmic techniques which may be easily incorporated.

### BRIEF SUMMARY

Principles of the invention provide systems and techniques for efficient large language model (LLM) generation through speculative decoding over homomorphic encryption. In one aspect, an exemplary method includes the operations of predicting, using a small language model, k tokens based on given input text; predicting, using a plurality of instances of a large language model (LLM), k LLM tokens based on the given input text; comparing each token produced by the small language model to a corresponding LLM token; concatenating each LLM token that resulted in a match with input tokens of a current context input; and generating text by predicting, using the small language model, an additional k tokens based on the concatenated tokens.

In one aspect, a computer program product comprises one or more tangible computer-readable storage media and program instructions stored on at least one of the one or more tangible computer-readable storage media, the program instructions executable by a processor, the program instructions comprising predicting, using a small language model, k tokens based on given input text; predicting, using a plurality of instances of a large language model (LLM), k LLM tokens based on the given input text; comparing each token produced by the small language model to a corresponding LLM token; concatenating each LLM token that resulted in a match with input tokens of a current context input; and generating text by predicting, using the small language model, an additional k tokens based on the concatenated tokens.

In one aspect, an apparatus comprises a memory and at least one processor, coupled to the memory, and operative to perform operations comprising predicting, using a small language model, k tokens based on given input text; predicting, using a plurality of instances of a large language model (LLM), k LLM tokens based on the given input text; comparing each token produced by the small language model to a corresponding LLM token; concatenating each LLM token that resulted in a match with input tokens of a current context input; and generating text by predicting, using the small language model, an additional k tokens based on the concatenated tokens.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
speculative decoding in a homomorphic encryption environment;
lower inference time while preserving accuracy and security, and therefore decrease computation costs, when performing inferencing using LLMs in a homomorphic encryption environment (ability to accelerate computations of LLMs using a draft model over FHE); and
acceleration of the generation of text by a generative machine learning model where security is provided by an encrypted environment.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 illustrates inference operations for a draft model m and verification operations for instances of a target model M, in accordance with exemplary embodiments;

FIG. 2 illustrates an approach to efficiently utilize large language models, in accordance with exemplary embodiments;

FIG. 3 is an exemplary system for performing speculative decoding over homomorphic encryption, in accordance with exemplary embodiments; and

FIG. 4 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Large language models (LLMs) generally tend to have lengthy inference times. Fully homomorphic encryption (FHE)-based LLMs exhibit even longer inference times due to the added complexity of their polynomial approximations. In exemplary embodiments, HE Layers (familiar to the skilled artisan) users are enabled to run LLMs with lower inference time while preserving accuracy and security, and thereby decreasing computation costs.

Conventional HE schemes support polynomial operations (such as addition, subtraction and multiplication) only. Large models (LMs) are functions which map a sequence of items from the vocabulary domain to the vocabulary range in an auto-regressive manner:

LM=f(T₁, . . . ,Tₙ;θ):Σ*->Σ

Let M be an LM with |θ_{M}| number of parameters. Given an ordered list of tokens, X:=(T₁, T₂, . . . , Tₙ), then M(X)=Oₙ₊₁ ∈Σ. The generation process of M involves a tremendous number of arithmetic operations, such as addition, subtraction, and multiplication, resulting in a large latency. M can be approximated by incorporating a smaller language model, m, which is defined by θₘ. Assuming m and M were trained sufficiently, whenever |θ|ₘ<<|θ|_{M}, it is reasonable to assume m generates tokens much faster than M, but is inferior in terms of accuracy as a language model. Exemplary embodiments minimize the inference time induced by the large model M, while preserving its accuracy.

### Speculative Decoding

Speculative decoding is a technique designed to expedite the inference process of large language models (LLMs). Conventional LLMs generate text sequentially, predicting one token at a time based on the preceding context, which can result in significant latency. Speculative decoding addresses this by utilizing a two-model approach:
drafting phase: a smaller, faster “draft” model, m, quickly generates a sequence of candidate tokens based on the input context; and
verification phase: the larger, more accurate “target” model, M, then reviews these candidate tokens (tokens that align with the target model's predictions are accepted and incorporated into the final output).

By processing multiple tokens in parallel during the drafting phase and subsequently verifying them, speculative decoding significantly reduces the number of sequential steps required during inference. This approach leads to faster text generation without substantially compromising accuracy.

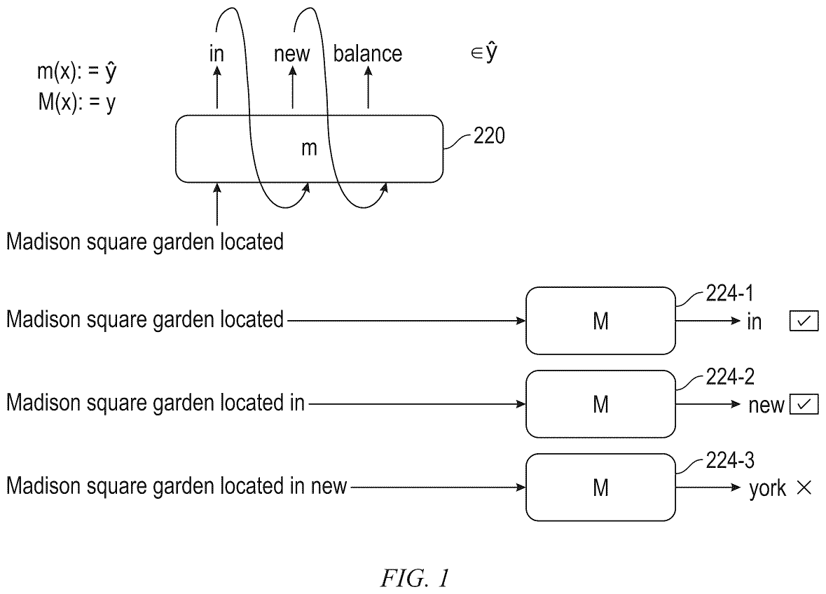

FIG. 1 illustrates inference operations for a draft model m 220 and verification operations for instances of a target model M 224-1, 224-2, 224-3, in accordance with exemplary embodiments. The draft model m 220 iteratively inputs a text string concatenated with the previous inference result. For example, an input of “Madison square garden located” input during a first iteration would generate the word (token) “in”. The input “Madison square garden located in” input during a second iteration would generate the word (token) “new”, and so on.

The target model M 224-1, 224-2, 224-3 verifies each predicted word in a substantially parallel fashion using instances of a target model M 224-1, 224-2, 224-3. Each instance of the target model M 224-1, 224-2, 224-3 verifies a corresponding token produced by the draft model m 220. The inferencing time of the draft model m 220 is relatively fast compared to the inferencing and verification times of the target models M 224-1, 224-2, 224-3. Thus, the time to perform three (or more) iterations of inferencing by the draft model m 220 may be similar to the time to verify the three (or more) tokens in parallel by the instances of the target model M 224-1, 224-2, 224-3.

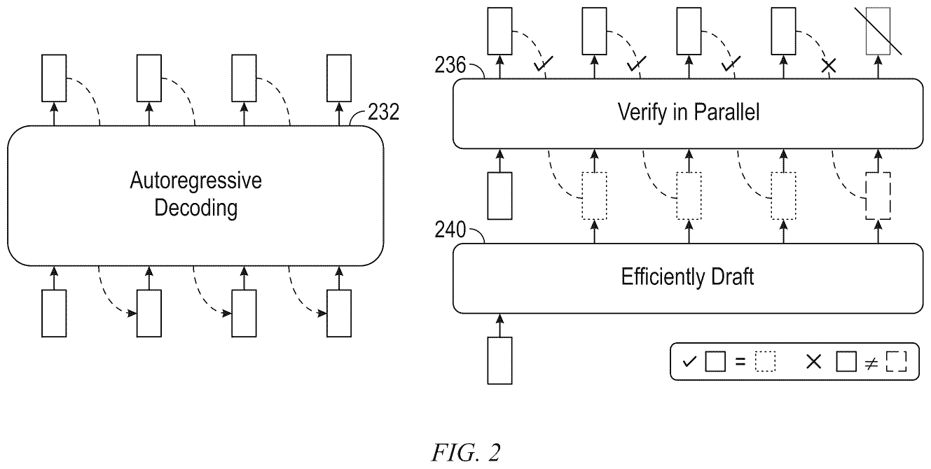

FIG. 2 illustrates an approach to efficiently utilize large language models, in accordance with exemplary embodiments. Auto-regressive decoding 232 is used to generate text. The text is efficiently drafted using a small language model approach 240 and the generated text is then verified in parallel using an LLM verification approach 236.

### High-Level Description

Generally, speculative decoding (SD) is an efficient technique for language models (LMs) generation. Conventional SD cannot be used as-is in an FHE environment. For example, selecting the next token using argmax is not supported natively in FHE. Similarly, the use of “if-else” schemes to decide whether the small language model predicted the correct token successfully is not supported natively in FHE. One or more embodiments advantageously provide an end-to-end technique that modifies a conventional speculative decoding algorithm by utilizing polynomials which approximate the argmax operation in order to select the next token greedily rather than use sampling. Moreover, a director-based aggregation mechanism is utilized which compares m's predicted tokens to M's predicted tokens using polynomial operations and then extracts the corresponding embedding vector of the validated predicted token for the next iteration. Furthermore, the predicted sequence length made by the small LM is updated after each iteration, by measuring its accuracy online. This variant achieves the same accuracy compared to the original large language model and offers faster inference in HE environments. M ore particularly, in exemplary embodiments, several mechanisms in speculative decoding are replaced in order to create an FHE-friendly speculative decoding system. The replaced mechanisms include:
speculative sampling is replaced with polynomial argmax selection from the vocabulary domain; and
decision points comparison is replaced with a director-based aggregation mechanism.

New mechanisms are also added to SD, including iterative refinement of the small LM generation sequence length through posterior updates on the client side using a metric from the server.

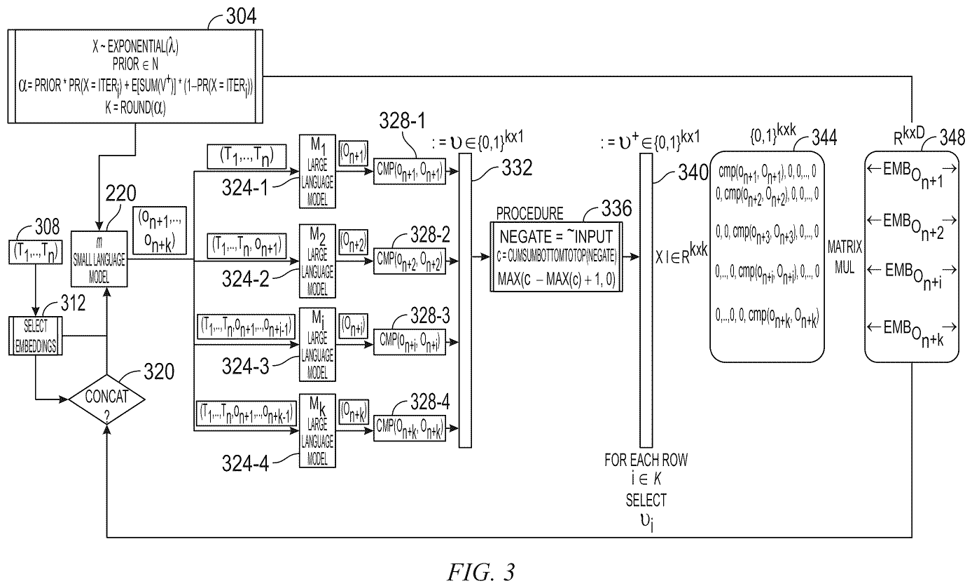

FIG. 3 depicts an exemplary system for performing speculative decoding over homomorphic encryption, in accordance with exemplary embodiments. A director-based aggregation mechanism includes a set of operations that prepares the input for the next iteration by concatenating the correct outputs of the LLM to previous input (only verified tokens are fed back.) The director-based aggregation mechanism uses only polynomial operations to make it compatible with the HE environment.

In exemplary embodiments, the number of tokens k to be predicted by the draft model m during a single iteration of the pipeline of FIG. 3 is periodically approximated by a token count selector 304. In exemplary embodiments, the number of tokens k to be predicted is updated after each iteration through the pipeline of FIG. 3.

In exemplary embodiments, the number of tokens k to be predicted is determined and provided to small language model 220. (It is noted that the initial value of k can be determined by feeding the same input to both the draft model m 220 and the target model M 224-1, 224-2, 224-3, and then determining the average correct sequence length of the draft model m 220 (until the first mistake, at which time the ground truth is determined by the predictions of the target model M 224-1, 224-2, 224-3.) The small language model 220 then predicts the next k tokens. The first prediction by the small language model 220 is based on the original input context (tokens/words) 308, as stored in select embeddings 312. During subsequent predictions by the small language model 220, the prediction is based on the current input context (as stored in the select embeddings 312) concatenated with the verified tokens of the previous iteration of the pipeline, as described more fully below.

K instances of the large language model 324-1, 324-2, 324-3, 324-4 then verify each of the k tokens in parallel (or as fast as the tokens are produced by the small language model 220). The tokens generated by the small language model 220 and the K instances of the large language model 324-1, 324-2, 324-3, 324-4 are the tokens with the highest probability (as determined using a polynomial argmax function). In exemplary embodiments, the argmax operation is estimated by performing tournament algorithms over ciphertext slots until the highest value index is reached. The skilled artisan will be familiar with such an approach from, for example, co-assigned US Patent Application Publication 2024-0171375 2024 May 23 of inventors Ramy Masalha, Ehud A haroni, Nir Drucker, Gilad Ezov, Hayim Shaul, and Omri Soceanu entitled Tournament Type Selection Operations on Encrypted Data.

Comparison units 328-1, 328-2, 328-3, 328-4 are utilized to perform comparisons to determine if each token produced by the draft model m 220 matches the token produced by the corresponding instance of the large language model 324-1, 324-2, 324-3, 324-4. Since only multiplication and addition are available in a homomorphic encryption environment, the comparison is a polynomial comparison. In exemplary embodiments, for polynomial comparison of two scalars a, b, step functions' composition are utilized over (a-b); for other FHE schemes, an equivalent method can be employed. For example, using Boolean gate to perform binary comparison and the like. The comparison units 328-1, 328-2, 328-3, 328-4 produce a “one” when a token produced by the draft model m 220 matches the token produced by the corresponding instance of the large language model 324-1, 324-2, 324-3, 324-4 and produces a “zero” otherwise. The outputs of the comparison units 328-1, 328-2, 328-3, 328-4 define a k×1 vector 332, which contains an element for each token of the corresponding large language model 324-1, 324-2, 324-3, 324-4. If the first two predictions of the small language model 220 are correct and the third is incorrect, the vector would be [1, 1, 0, 0]. It is noted that, once the first erroneous token is encountered and marked as zero, all the subsequent tokens in the current iteration are also indicated as a zero in the vector 332 (regardless of the verification state of the token).

As long as the inputs to a given large language model 324-1, 324-2, 324-3, 324-4 are correct, the output of the given large language model 324-1, 324-2, 324-3, 324-4 is treated as being correct. Thus, if the first two predictions of the small language model 220 are correct and the third is incorrect, the output of the third instance of the large language model 324-3 is treated as correct since it only utilizes the first two tokens produced by the small language model 220. For efficiency, the output of the third instance of the large language model 324-1, 324-2, 324-3, 324-4 is therefore utilized in the concatenation operation. To facilitate this aspect, a procedure 336 updates the vector 332 to produce k×1 indicator vector 340. The indicator vector is set to indicate that an additional token is valid. Thus, in the above example, a vector 332 of [1, 1, 0, 0] would generate an indicator vector 340 of [1, 1, 1, 0].

In exemplary embodiments, the indicator vector 340 is multiplied by the identity matrix to produce k×k diagonal matrix 344, which inherently includes the elements of the indicator vector 340 along the diagonal of the diagonal matrix 344. A matrix multiplication is then performed between the diagonal matrix 344 and the embedding matrix induced by M's k output tokens' embedding to produce token vectors 348, which includes the embedding vector for each of the verified tokens.

The verified embedding vectors of the token vector 348 are then concatenated with the current context input (select embeddings) 312 (operation 320) and the results are fed into the small language model 220 to perform the next iteration of the pipeline of FIG. 3.

In exemplary embodiments, as noted above, the token count selector 304 periodically updates the number of tokens k to be generated by the small language model 220 (such as after each iteration of the pipeline of FIG. 3). To accomplish this, the count of correct predictions generated by the small language model 220 for a given iteration are fed back to the token count selector 304. The count of correct predictions can be determined at various points in the pipeline, such as during the generation of the token vector 348 (as illustrated), during the generation of the vector 332, and the like. In exemplary embodiments, the count k is updated based on the following algorithm:

Let X~Exp(λ), k₀∈N

αᵢ=kᵢ₋₁*P(X=Iterᵢ)+E[Sum(ν⁺)]*(1−P(X=Iterᵢ))

kᵢ=round(αᵢ)

(ν⁺ is depicted as the indicator vector 340 in the document). The above formula is an example of how k can be updated using the real accuracy of m with respect to M, and by taking into consideration the input data the SD algorithm is running on. For example, X, a weight generated by an exponential distribution, does not have to distribute exponentially, but can be distributed differently (depending on empirical experiments).

### Algorithm

In exemplary embodiments, the algorithm presented below is used to provide speculative decoding in a homomorphic encryption environment.

Given the teachings herein, the skilled artisan will be able to implement one or more embodiments by adapting known processes/components, such as homomorphic encryption, specifically, approximated homomorphic encryption (CKKS); language models; speculative decoding; and polynomial approximation for ArgMax, Max. and Compare.

Furthermore, one or more embodiments employ novel processes/components as disclosed herein, including:
Polynomial Argmax selection from the vocabulary domain. Utilizing techniques that approximate the argmax operator for LM generation purposes, where the next token is selected from the vocabulary space, is non-trivial.
Director-based aggregation mechanism.
Enabling mechanism to build the input for the next iteration using polynomial operators as opposed to the “if-else” scheme presented originally.
Client-based iterative refinement of the small LM generation sequence length through posterior updates on the client side using a single input from the server of the agreement of the small LM m and the LLM M.

Let (T₁, T₂, . . . , Tₙ) be a sequence of tokens fed into a small language model m 220.

Let (oₙ₊₁, oₙ₊₂, . . . , oₙ₊ₖ) be m's output computed in an autoregressive manner.

Let (M₁, M₂, . . . , Mₖ) be k copies of a large language model 324-1, 324-2, 324-3, 324-4.

For each i∈K, calculate parallelly:

Oₙ₊ᵢ=M(T₁,T₂, . . . ,Tₙ,oₙ₊₁, . . . ,oₙ₊ᵢ₋₁)

$${O}_{n + 1}^{n + k} = [ {O}_{n + i} ] \vert 1 \leq i \leq k$$

Let v:=[Pcmp(oₙ₊₁, Oₙ₊₁), . . . , Pcmp(oₙ₊ₖ, Oₙ₊ₖ)]

Let c [symbol] CumSumBottomToTop(~v)

Let v⁺ [symbol] Pmax(c−Pmax(c)+1, 0)

$$For each row {v}_{i}^{+} over {v}_{+} :$$

$${Expanded}_{{v}_{i}^{+}} = {v}_{i}^{+} * I ∈ {R}^{k \times k}$$

$${Expanded}_{{v}^{+}} = [ {Expanded}_{{v}_{i}^{+}} ] \vert 1 \leq i \leq k$$

Suppose a prior was already set as k, calculate new k at iteration j:

X~Exp(λ);λ∈N

α=prior*P(X=Iterⱼ)+E_{Over samples}[Sum(ν⁺)]]*(1−p(X=Iterⱼ))

k=round(α)

Input for next iteration, e.g., the j-th iteration:

$${I}_{j} = Concat ( {Emb}_{{T}_{1}} , ¨ , {Emb}_{{T}_{n}} , {Expanded}_{{v}^{+}} * {O}_{n + 1}^{n + k} )$$

Given the discussion thus far, it will be appreciated that, in general terms, an exemplary method, according to an aspect of the invention, includes the operations of predicting, using a small language model 220, k tokens based on given input text; predicting, using a plurality of instances of a large language model (LLM) 324-1, 324-2, 324-3, 324-4, k LLM tokens based on the given input text; comparing each token produced by the small language model 220 to a corresponding LLM token; concatenating each LLM token that resulted in a match with input tokens of a current context input 308 (operation 320); and generating text by predicting, using the small language model 220, an additional k tokens based on the concatenated tokens.

In exemplary embodiments, a count of tokens k to be predicted by the small language model 220 is approximated during each iteration of the predicting operation and the count of tokens k is provided to the small language model 220.

In exemplary embodiments, the approximating of the count of tokens k is performed after each iteration of the method.

In exemplary embodiments, the comparing of each token is performed using a polynomial comparison.

In exemplary embodiments, the predicting of the predicted k LLM tokens is performed in parallel.

In exemplary embodiments, the predicting of the predicted k LLM tokens is based on a highest probability of each token as determined using a polynomial argmax function.

In exemplary embodiments, the comparing of each token produces a k×1 vector 332 comprising a “one” corresponding to a token produced by the small language model 220 that matches the corresponding LLM token and a “zero” otherwise.

In exemplary embodiments, the vector 332 is updated to produce a k×1 indicator vector 340 and to indicate that an additional token is valid.

In exemplary embodiments, the indicator vector 340 is multiplied by an identity matrix to produce a k×k diagonal matrix 344 that indicates the LLM tokens that resulted in the match. A matrix multiplication is then performed between the diagonal matrix 344 and the embedding matrix induced by M's k output tokens' embedding to produce token vectors 348, which includes the embedding vector for each of the verified tokens.

In exemplary embodiments, a matrix multiplication is performed using the diagonal matrix 344 to produce a token vector 348 that identifies the LLM tokens that resulted in the match.

In exemplary embodiments, a count of tokens k to be predicted by the small language model 220 is approximated based on a count of correct predictions by the small language model 220 for a given iteration and the count of tokens k is provided to the small language model 220.

In exemplary embodiments, the approximating of the count of tokens k is performed after each iteration of the method.

In exemplary embodiments, the predicting using a small language model 220 and the predicting using the plurality of instances of the large language model (LLM) 324-1, 324-2, 324-3, 324-4 is performed in a homomorphic encryption environment.

In one aspect, a computer program product comprises one or more tangible computer-readable storage media and program instructions stored on at least one of the one or more tangible computer-readable storage media, the program instructions executable by a processor, the program instructions comprising predicting, using a small language model 220, k tokens based on given input text; predicting, using a plurality of instances of a large language model (LLM) 324-1, 324-2, 324-3, 324-4, k LLM tokens based on the given input text; comparing each token produced by the small language model 220 to a corresponding LLM token; concatenating each LLM token that resulted in a match with input tokens of a current context input 308 (operation 320); and generating text by predicting, using the small language model 220, an additional k tokens based on the concatenated tokens.

In one aspect, an apparatus comprises a memory and at least one processor, coupled to the memory, and operative to perform operations comprising predicting, using a small language model 220, k tokens based on given input text; predicting, using a plurality of instances of a large language model (LLM) 324-1, 324-2, 324-3, 324-4, k LLM tokens based on the given input text; comparing each token produced by the small language model 220 to a corresponding LLM token; concatenating each LLM token that resulted in a match with input tokens of a current context input 308 (operation 320); and generating text by predicting, using the small language model 220, an additional k tokens based on the concatenated tokens.

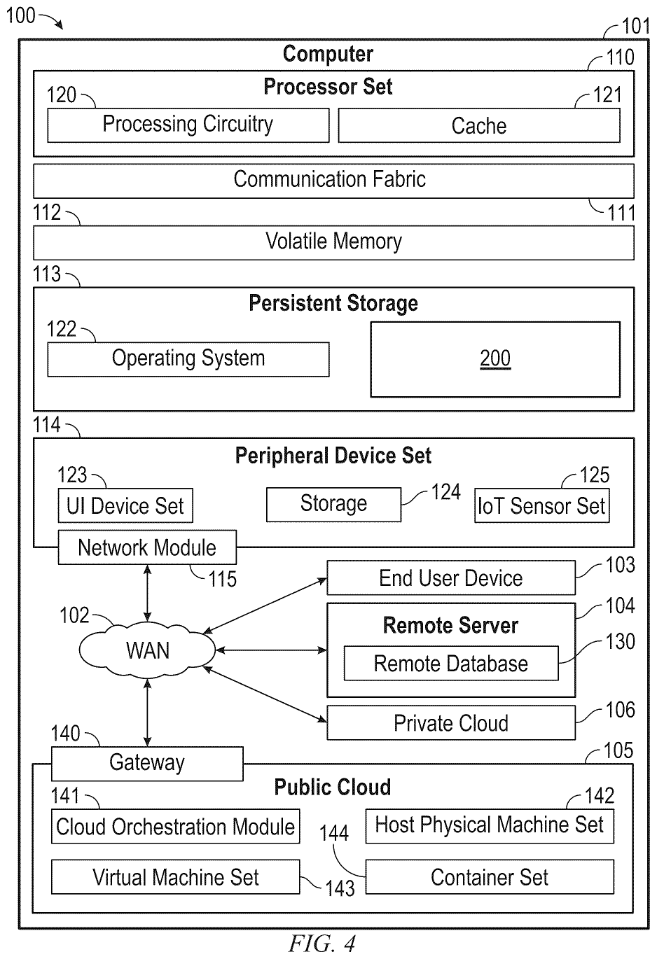

Refer now to FIG. 4. Purely by way of example and not limitation, the blocks in the block diagram can be implemented by data structures and computer code that implement the logic described herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a system 200 that implements at least some aspects of efficient large language model generation through speculative decoding over homomorphic encryption. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 4. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
predicting, using a small language model, k tokens based on given input text;
predicting, using a plurality of instances of a large language model (LLM), k LLM tokens based on the given input text;
comparing each token produced by the small language model to a corresponding LLM token;
concatenating each LLM token that resulted in a match with input tokens of a current context input; and
generating text by predicting, using the small language model, an additional k tokens based on the concatenated tokens.

2. The method of claim 1, further comprising approximating a count of tokens k to be predicted by the small language model during each iteration of the first predicting operation and providing the count of tokens k to the small language model.

3. The method of claim 2, wherein the approximating of the count of tokens k is performed after each iteration of the method.

4. The method of claim 2, wherein the approximating of the count of tokens k is performed after each iteration of the method.

5. The method of claim 1, wherein the comparing of each token is performed using a polynomial comparison.

6. The method of claim 1, wherein the predicting of the predicted k LLM tokens is performed in parallel.

7. The method of claim 1, wherein the predicting of the predicted k LLM tokens is based on a highest probability of each token as determined using a polynomial argmax function.

8. The method of claim 1, wherein the comparing of each token produces a k×1 vector comprising a “one” corresponding to a token produced by the small language model that matches the corresponding LLM token and a “zero” otherwise.

9. The method of claim 8, further comprising updating the k×1 vector to produce a k×1 indicator vector and to indicate that an additional token is valid.

10. The method of claim 9, further comprising multiplying the indicator vector by an identity matrix to produce a k×k diagonal matrix that indicates the LLM tokens that resulted in the match.

11. The method of claim 10, further comprising performing a matrix multiplication using the diagonal matrix to produce a token vector that identifies the LLM tokens that resulted in the match.

12. The method of claim 1, further comprising approximating a count of tokens k to be predicted by the small language model based on a count of correct predictions by the small language model for a given iteration and providing the count of tokens k to the small language model.

13. The method of claim 1, wherein the predicting using a small language model and the predicting using the plurality of instances of the large language model (LLM) are performed in a homomorphic encryption environment.

14. A computer program product, comprising:
one or more tangible computer-readable storage media and program instructions stored on at least one of the one or more tangible computer-readable storage media, the program instructions executable by a processor, the program instructions comprising:
predicting, using a small language model, k tokens based on given input text;
predicting, using a plurality of instances of a large language model (LLM), k LLM tokens based on the given input text;
comparing each token produced by the small language model to a corresponding LLM token;
concatenating each LLM token that resulted in a match with input tokens of a current context input; and
generating text by predicting, using the small language model, an additional k tokens based on the concatenated tokens.

15. A system comprising:
a memory; and
at least one processor, coupled to said memory, and operative to perform operations comprising:
predicting, using a small language model, k tokens based on given input text;
predicting, using a plurality of instances of a large language model (LLM), k LLM tokens based on the given input text;
comparing each token produced by the small language model to a corresponding LLM token;
concatenating each LLM token that resulted in a match with input tokens of a current context input; and
generating text by predicting, using the small language model, an additional k tokens based on the concatenated tokens.

16. The system of claim 15, the operations further comprising approximating a count of tokens k to be predicted by the small language model during each iteration of the predicting operation and providing the count of tokens k to the small language model.

17. The system of claim 15, wherein the predicting of the predicted k LLM tokens is based on a highest probability of each token as determined using a polynomial argmax function.

18. The system of claim 15, wherein the comparing of each token produces a k×1 vector comprising a “one” corresponding to a token produced by the small language model that matches the corresponding LLM token and a “zero” otherwise.

19. The system of claim 18, the operations further comprising:
updating the k×1 vector to produce a k×1 indicator vector and to indicate that an additional token is valid;
multiplying the indicator vector by an identity matrix to produce a k×k diagonal matrix that indicates the LLM tokens that resulted in the match; and
performing a matrix multiplication using the diagonal matrix to produce a token vector that identifies the LLM tokens that resulted in the match.

20. The system of claim 15, the operations further comprising approximating a count of tokens k to be predicted by the small language model based on a count of correct predictions by the small language model for a given iteration and providing the count of tokens k to the small language model.
